(19) United States
(12) Patent Application Publication
(10) Pub. No.: US 2004/0067737 A1
(43) Pub. Date: Apr. 8, 2004

(54) Wireless signal receiver for computer peripheral input devices

(76) Inventor: Hsiao Ming Kuo, Taipei (TW)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 10/615,889

(22) Filed: Jul. 8, 2003

(30) Foreign Application Priority Data
Jul. 19, 2002 (TW) 091211030

(51) Int. Cl. H04B 7/15

(52) U.S. Cl. 455/90.3; 455/11.1

(57) ABSTRACT

A wireless signal receiver for computer peripheral input devices is provided, that is capable of receiving and switching the wireless signals sent from wireless computer peripheral input devices to a computer platform connecting the wireless signal receiver. The wireless signal receiver includes a housing for accommodating a circuit module for receiving wireless signals from a wireless mouse, a wireless keyboard and a wireless gamepad, and a connector coupled to the housing and electrically interconnected with the circuit module and the computer platform, allowing the wireless signals received by the circuit module unit to be sent to the computer platform via the connector and a power source of the computer platform to be supplied to the circuit module unit. With the use of the circuit module unit, the computer platform requires merely a communication port for electrical connection with the wireless signal receiver for receiving wireless signals from various computer peripheral input devices.

### FIELD OF THE INVENTION

The present invention relates generally to wireless signal receivers for computer peripheral input devices, and, more particularly, to a wireless signal receiver for receiving wireless signals from computer peripheral input devices and sending the wireless signals to a computer platform.

### BACKGROUND OF THE INVENTION

When a conventional computer peripheral input device is connected to a personal computer, it allows a user to enter data or control signals into the personal computer. Conventional computer peripheral input devices include mice, keyboards, gamepads, etc.

Conventional mice, keyboards or gamepads connect with the input/output ports of a personal computer via cables with specific signal connectors and protocols. For example, a mouse is adapted to connect with the serial port, PS/2 port or a USB port; the keyboard is adapted to connect with the keyboard port, PS/2 port, or a USB port; and, the gamepad may connect with the pertinent gamepad port, PS/2 port or a USB port.

However, in practice, computer peripheral devices with cables have serious disadvantages in that the cables occupy a lot of space on the space-limited desktop and also restrict the physical arrangement of each device due to limited cable length. Furthermore, cables often become entangled, making it frustrating to add or remove devices.

One way to solve the problems mentioned above is to use wireless computer peripheral input devices, including wireless mice, wireless keyboards and wireless video gamepads. In practice, each of the wireless computer peripheral input devices requires a wireless receiver that is connected with a corresponding communication port of a personal computer. For example, the PS/2 port is used to be connected with a wireless mouse signal receiver for receiving wireless signals sent from a wireless mouse, while the UCB port is used to be connected with a wireless keyboard signal receiver for receiving wireless signals sent from a wireless keyboard. However, when a user wishes to use a wireless gamepad, the gamepad can be used only after removing, for instance, the wireless mouse signal receiver from the PS/2 port and then connecting the gamepad signal receiver to the PS/2 port. This connection process is cumbersome and thus in need of improvement.

### SUMMARY OF THE INVENTION

The primary objective of the present invention is to provide a wireless signal receiver for use with computer peripheral input devices that is capable of receiving wireless signals sent from a wireless mouse, a wireless keyboard, and a wireless gamepad, allowing a personal computer to require merely a communication port to connect to the wireless signal receiver.

In accordance with the above and other objectives, the present invention provides a wireless signal receiver for computer peripheral input devices, including at least a housing; a circuit module including at least a wireless signal receiving module unit for receiving the wireless signals sent from a wireless mouse mounted in the housing, a wireless keyboard, and a wireless gamepad; a wireless mouse signal demodulation module unit, coupled with the wireless signal receiving module unit for demodulating wireless mouse signals received by the wireless signal receiving module unit into mouse signals in digital form; a wireless keyboard signal demodulation module unit coupled with the wireless signal receiving module unit for demodulating wireless keyboard signals received by the wireless signal receiving module unit into keyboard signals in digital form; a wireless gamepad signal demodulation module unit coupled with the wireless signal receiving module unit for demodulating wireless gamepad signals received by the wireless signal receiving module unit into gamepad signals in digital form; and a connector mounted in the housing and having a signal transmission control module unit coupled with the wireless mouse signal demodulation module unit, the wireless keyboard signal demodulation module unit, and the wireless gamepad signal demodulation module unit for transmitting the digital mouse signals, digital keyboard signals and the digital gamepad signals from the wireless mouse signal demodulation module unit, the wireless keyboard signal demodulation module unit, and the wireless gamepad demodulation module unit into a computer platform connected with the wireless signal receiver via a communication port of the computer platform.

In contrast to conventional wireless computer peripheral input devices, which one wireless signal receiver must be removed before inserting another wireless signal receiver, the present invention allows the above three mentioned wireless computer peripheral input devices, i.e. the wireless mouse, the wireless keyboard, and the wireless gamepad to use only one communication port to connect with a computer platform.

### BRIEF DESCRIPTION OF THE DRAWINGS

FIG. 1 is an explosive view of the wireless signal receiver according to the present invention.

FIG. 2 is a structure diagram for the present invention.

FIG. 3 is a sectional view of the upper cover for the present invention.

FIG. 4 is an application structure diagram for the present invention.

FIG. 5 is a basic system structure diagram for the present invention.

### EMBODIMENTS OF THE INVENTION

A wireless signal receiver for computer peripheral input devices according to the present invention is disclosed in detail in the following embodiments in conjunction with the accompanying drawings.

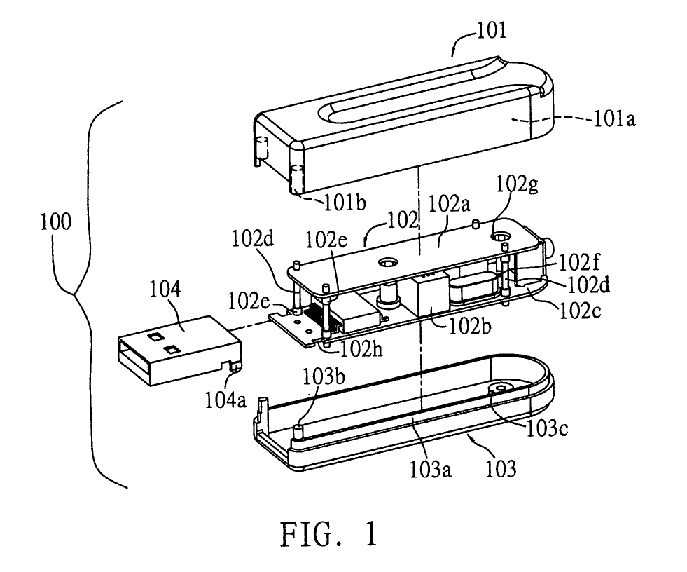

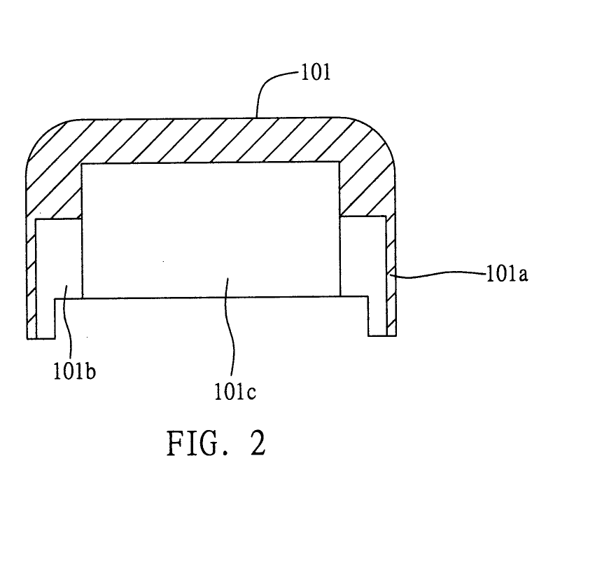

As shown in FIG. 1, the wireless signal receiver 100 for computer peripheral input devices of the present invention includes an upper cover 101, an opposing lower cover 103, a circuit module assembly 102 received in the housing formed by the upper cover 101 and the lower cover 103, and a connector 104 coupled with the upper cover 101 and the lower cover 103, adapted for being combined with the upper cover 101 to form a housing. The upper cover 101 is provided with a recess 101c so as to, after being combined with the lower cover 103, form the housing for the circuit module 102 to be contained therein, as shown in FIG. 2. The circuit module assembly 102 is designed for receiving wireless mouse signals from a wireless mouse, wireless keyboard signals from a wireless keyboard and wireless gamepad signals from a wireless gamepad, as well as for transmitting via the connector 104 the received wireless signals to a computer platform connected with the wireless signal receiver 100.

A protruding portion 101a, as shown in FIG. 2, is formed with the upper cover 101 for coupling the upper cover 101 onto the lower cover 103. Also, a pair of locking holes 101b having an inner surface curved inward are formed at a position corresponding to the protruding portion 101a, so as to couple with the protruding portion 101a of the upper cover 101. In a similar manner, a pair of locking posts 103b are formed with the lower cover 103 corresponding in position to the locking holes 101b of the upper cover 101. The upper cover 101 is securely coupled with the bottom cover 103 by the engagement of the protruding portion 101a of the upper cover 101 and the recession 103a of the lower cover 103, as well as by the insertion of the locking posts 103b of the lower cover 103 into the locking holes 101b of the upper cover 101.

The circuit module assembly 102 includes an antenna module board 102a, capable of receiving the wireless signals sent from wireless computer peripheral input devices, a circuit assembly 102b capable of demodulating and transmitting the signals from the wireless computer peripheral input devices, and a printed circuit board 102c for connecting with the circuit assembly 102b.

A plurality of connection pillars 102d are provided to securely couple the antenna module board 102a to the printed circuit board 102c, on which the circuit assembly 102b is electrically mounted. A protruding rim 102e with a larger axial radius than the connection pillars 102d, is formed on both the upper and lower ends of each of the connection pillars 102d. The lower protruding rim 102e provides a means to firmly engage the connection pillars 102d with the printed circuit board 102c, while the upper protruding rim 102e of the connection pillars 102d provides a means to firmly engage the connection pillars 102d with the antenna module board 102a.

Screw holes 103c, 102f, and 102g are formed in the lower bottom cover 103, the printed circuit board 102c, and the antenna module board 102a, respectively. A fastening screw can then in turn be inserted through the holes 103c, 102f and 102g in order to securely fasten the circuit module assembly 102 to the bottom cover 103. It should be understood that the connection of the circuit module assembly 102 to the bottom cover 103 could be accomplished by any applicable conventional approaches, other than the screw means depicted as above.

On the printed circuit board 102c of the circuit module assembly 102, locking notches 102h are formed on both sides of the circuit board 102c. Correspondingly, a pair of locking protrusions 104a is formed on both sides of the connector 104, allowing the connector 104 to be firmly and electrically connected with the circuit module assembly 102 by the engagement of the locking protrusions 104a with the locking holes 102h. By this arrangement, as shown in FIG. 1, the connector 104 is capable of being used as a universal serial bus (USB) communication port or a PS/2 communication port for electrical connection to a computer platform.

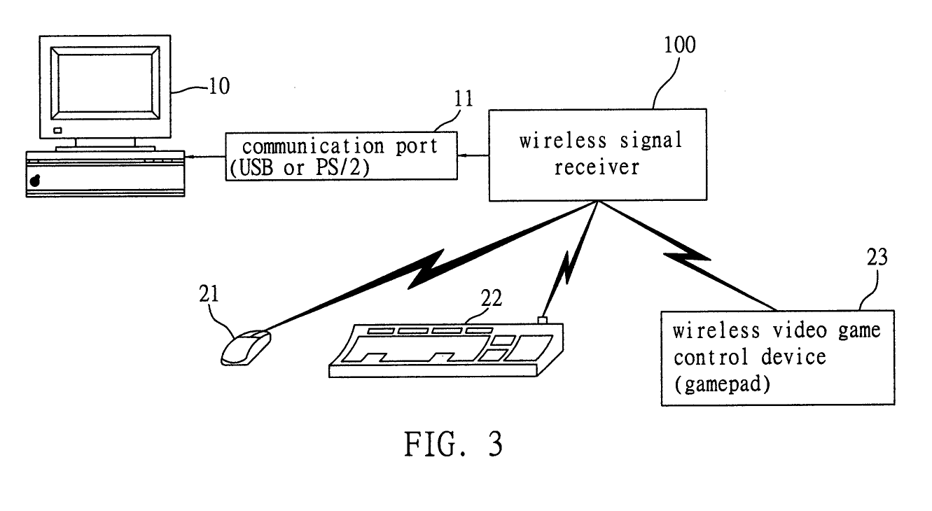

As shown in FIG. 3, the wireless signal receiver 100 of the present invention is, in practice, connected with a computer platform 10 having a communication port 11, such as a USB communication port or a PS/2 communication port. The communication port 11 is adapted to be used for transferring the signals sent from wireless computer peripheral input devices, including a wireless mouse 21, a wireless keyboard 22, and a wireless gamepad 23, via the wireless signal receiver 100.

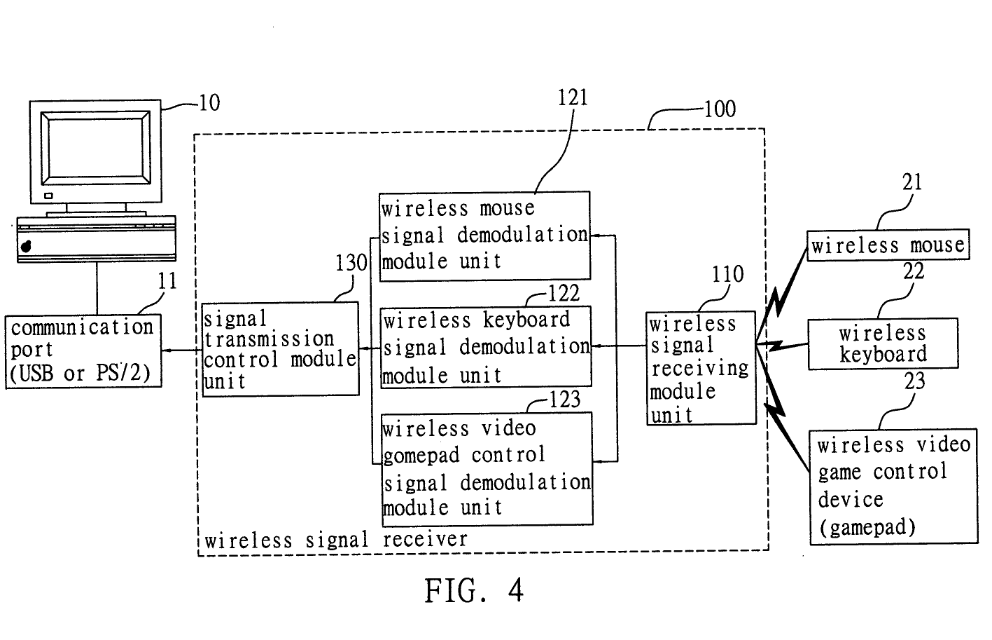

FIG. 4 illustrates the system structure of the wireless signal receiver 100 for computer peripheral input devices according to the present invention, when in association with the computer platform 10 and computer peripheral input devices 21, 22 and 23. As shown, the system structure of the wireless signal receiver 100 of the present invention includes, but not limited to, a wireless signal receiving module 110, a wireless mouse signal demodulation module 121, a wireless keyboard signal demodulation module 122, a wireless gamepad signal demodulation module 123, and a signal transmission control module 130.

The wireless signal receiving module 110 is provided with, for example, a planar receiving antenna functions for receiving the signals from the wireless mouse 21, the wireless keyboard 22, and the wireless gamepad 23. The frequency range for receiving the wireless signals depends on the frequency range of the signals sent from the wireless mouse 21, the wireless keyboard 22, and the wireless gamepad 23. The standard specification of the frequency range, for example, is 27.1±0.163 MHz.

The wireless mouse signal demodulation module 121 is coupled with the wireless signal receiving module 110, permitting the wireless mouse signals received by the wireless signal receiving module 110 to be demodulated into mouse signals in digital form. Since the demodulation of the received signals via the wireless mouse signal demodulation module 121 is conventional in the prior art, further detailed discussion is omitted.

Likewise, the wireless keyboard demodulation module 122 is coupled with the wireless signal receiving module 110, permitting the wireless keyboard signals received by the wireless signal receiving module 110 to be demodulated into keyboard signals in digital form. Since the demodulation of the received signals via the wireless keyboard signal demodulation module 122 is conventional in the prior art, further detailed discussion is omitted.

The wireless gamepad demodulation module 123 is also coupled with the wireless signal receiving module 110, permitting the wireless gamepad signals received by the wireless signal receiving module 110 to be demodulated into gamepad signals in digital form. Since the demodulation of the received signals via wireless gamepad signal demodulation module 122 is conventional in the prior art, further detailed discussion is omitted.

The signal transmission control module 130 is coupled with each of the wireless mouse signal demodulation module 121, the wireless keyboard signal demodulation module 122, and the wireless gamepad demodulation module 123, allowing digital mouse signals, digital keyboard signals, and digital gamepad signals, generated by the wireless mouse signal demodulation module 121, the wireless keyboard signal demodulation module 122 and the wireless gamepad signal demodulation module 123, respectively, to be sent to the computer platform 10 through the communication port 11.

In practice, when a user moves the wireless mouse 21 by hand, the wireless mouse 21 generates corresponding wireless mouse signals. The wireless mouse signals are then received by the wireless signal receiving module 110 of the wireless signal receiver 100 of this invention which is electrically connected with the computer platform 10. The wireless mouse signal demodulation module 121 then demodulates the received mouse signals into digital form. Finally, via the signals transmission control module 130, the demodulated digital mouse signals are transmitted to the computer platform 10 through the communication port 11 to make the computer platform 10 to perform the corresponding cursor control.

Likewise, when a user interacts with the computer platform 10 via the wireless keyboard 22, the wireless keyboard 22 generates corresponding wireless keyboard signals, which are then received by the wireless signal receiving module 110 of the wireless signal receiver 100 electrically connected with the computer platform 10. The wireless keyboard signal demodulation module 122 accordingly demodulates the received keyboard signals into digital form. Finally, via the signal transmission control module 130, the demodulated digital keyboard signals are transmitted to the computer platform 10 through the communication port 11 to make the computer platform 10 to perform the corresponding text or symbol input.

Similarly, when a user controls the wireless gamepad 23 by hand, the wireless gamepad 23 generates corresponding wireless gamepad signals. The wireless gamepad signals are then received by the wireless signal receiving module 110 of the wireless signal receiver 100 electrically connected with the computer platform 10. The wireless gamepad signal demodulation module 123 accordingly demodulates the gamepad signals into digital form. Finally, via the signal transmission control module 130, the demodulated digital gamepad signals are transmitted to the computer platform 10 through the communication port 11 to make the computer platform 10 to perform the corresponding game control.

In summary, the present invention provides a novel wireless signal receiver for computer peripheral input devices, which is capable of transmitting various wireless signals sent from various computer peripheral input devices to a computer platform that requires merely a communication port for electrical connection with the wireless signal receiver. As the computer platform is allowed to form with only one communication port, the computer device is provided with a high design flexibility than conventional ones that require a couple of different communication ports for various wireless signal receiving devices to connect thereto. As a result, manual change of various wireless signal receiving devices is waived and receipt of wireless signals by a computer platform is made more convenient and easier to implement than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed:

1. A wireless signal receiver for computer peripheral devices, comprising:
a housing;
a circuit module mounted in the housing for receiving and demodulating into digital form wireless signals sent from a wireless mouse, a wireless keyboard, and a wireless gamepad; and
a connector coupled with the housing and being electrically connected with the circuit module, for transmitting the wireless signals in digital form received by the circuit module to a computer platform connected with the wireless signal receiver via the connector;

2. The wireless signal receiver of claim 1, wherein the circuit module comprises at least a wireless signal receiving module unit, a wireless mouse signal demodulation module unit, a wireless keyboard signal demodulation module unit, and a wireless gamepad signal demodulation module unit.

3. The wireless signal receiver of claim 1, wherein the connector includes at least a signal transmission control module.

4. The wireless signal receiver of claim 1, wherein the computer platform is provided with a communication port for electrical connection to the connector.

5. The wireless signal receiver of claim 1, wherein the communication port is a universal signal bus (USB) communication port.

6. The wireless signal receiver of claim 1, wherein the communication port is a PS/2 communication port.

7. The wireless signal receiver of claim 1, wherein the housing is consisted of an upper cover and an opposing lower cover for being coupled with the upper cover.

8. The wireless signal receiver of claim 2, wherein the wireless signal receiving module unit is constructed as an antenna module board and the wireless mouse signal demodulation module unit, the wireless keyboard signal demodulation module unit, and the wireless gamepad signal demodulation module unit are integrally constructed as a circuit assembly electrically connected to the antenna module board via a printed circuit board.
